(19) United States
(12) Patent Application Publication
(10) Pub. No.: US 2014/0208328 A1
(43) Pub. Date: Jul. 24, 2014

(54) METHOD FOR TERMINAL ACCELERATION, TERMINAL AND STORAGE MEDIUM

(71) Applicant: TENCENT TECHNOLOGY (SHENZHEN) COMPANY LIMITED, Shenzhen (CN)

(72) Inventor: Qiang CHEN, Shenzhen (CN)

(73) Assignee: TENCENT TECHNOLOGY (SHENZHEN) COMPANY LIMITED, Shenzhen (CN)

(21) Appl. No.: 14/226,299

(22) Filed: Mar. 26, 2014

Related U.S. Application Data
(63) Continuation of application No. PCT/CN2013/087170, filed on Nov. 14, 2013.

(30) Foreign Application Priority Data
Jan. 5, 2013 (CN) 201310002268.4

(51) Int. Cl. G06F 9/50

(52) U.S. Cl. CPC G06F 9/5016
USPC 718/103; 718/104

(57) ABSTRACT

A method for terminal acceleration, a terminal and a storage medium is provided. The method includes steps of: detecting a memory resource occupied by all running application processes; determining whether the memory resource occupied by all running application processes reaches or is greater than a preset memory threshold; and terminating the running of at least one of all the running application processes according to the preset terminating conditions, when the memory resource occupied by all the running application processes reaches or is greater than the preset memory threshold, so that the terminal can be automatically accelerated according to the current utilization condition of its memory and the running application processes, the operating speed of the terminal may be improved, and the functions of the terminal may be further diversified.

### CROSS-REFERENCE TO RELATED APPLICATIONS

This application claims priority to and is a continuation application of PCT/CN2013/087170, filed on Nov. 14, 2013 and entitled “METHOD FOR TERMINAL ACCELERATION, TERMINAL AND STORAGE MEDIUM”, which claims the benefit of Chinese Application No. 201310002268.4 filed on Jan. 5, 2013 by Tencent Technology (Shenzhen) Co., Ltd., titled “METHOD FOR TERMINAL ACCELERATION, AND TERMINAL”, which are incorporated herein by reference in their entirety.

### FIELD OF THE INVENTION

The present disclosure relates to the field of communication technologies, and in particular to a method for terminal acceleration, a terminal and a storage medium.

### BACKGROUND OF THE INVENTION

When too many applications are running on a terminal and the storage space occupied by the running applications exceeds the tolerant redundancy of the terminal memory, the terminal may suffer from a slow running speed or even a system breakdown. However, many of these running applications are processes of secondary services, which are not necessary to be run by the terminal at all. At present, the processes of secondary services are usually ended manually by a user, but not by the terminal automatically according to the current actual running situation.

For example, manual operations from a user are necessary for a typical software for accelerating a terminal, such as a mobile phone butler on a mobile terminal, to accelerate the mobile phone, and the software cannot automatically terminate the running of an unnecessary application process according to the utilization condition of the memory of the terminal.

### SUMMARY OF THE INVENTION

In one aspect of the embodiments of the invention is to provide a method for terminal acceleration, a terminal and a storage medium, for the purpose of automatically accelerating a terminal.

An embodiment of the invention discloses a method for terminal acceleration, using on a terminal, including:

detecting a memory resource occupied by all running application processes

determining whether the memory resource occupied by all running application processes reaches or is greater than a preset memory threshold; and

terminating the running of at least one of all the running application processes according to the preset terminating conditions, when the memory resource occupied by all the running application processes reaches or is greater than the preset memory threshold.

An embodiment of the invention further discloses a terminal, including:

a detecting module used for detecting a memory resource occupied by all running application processes;

a determining module used for detecting whether the memory resource occupied by all running application processes reaches or is greater than a preset memory threshold; and

a terminating module used for terminating the running of at least one of all the running application processes according to the preset terminating conditions, when the detecting module detects that the memory resource occupied by all the running application processes reaches or is greater than the preset memory threshold.

An embodiment of the invention further discloses a storage medium containing computer-executable instructions, and the computer-executable instructions, when executed by a computer processor, performs:

detecting a memory resource occupied by all running application processes;

determining whether the memory resource occupied by all running application processes reaches or is greater than a preset memory threshold; and

terminating the running of at least one of all the running application processes according to the preset terminating conditions, when the memory resource occupied by all the running application processes reaches or is greater than the preset memory threshold.

In the embodiments of the invention, when detecting that the memory resource occupied by all running application processes reaches or is greater than a preset memory threshold, a terminal terminates the running of at least one of all the running application processes, so that the terminal can be automatically accelerated according to the current utilization condition of the memory and the running processes, thereby improving the performance of the terminal.

### BRIEF DESCRIPTION OF THE DRAWINGS

FIG. 1 is a schematic flow chart of a method for terminal acceleration according to an embodiment of the invention;

FIG. 2 is a schematic flow chart of another method for terminal acceleration according to an embodiment of the invention

FIG. 3 is a schematic flow chart of yet another method for terminal acceleration according to an embodiment of the invention;

FIG. 4 is a structural representation of a terminal according to an embodiment of the invention;

FIG. 5 is a structural representation of another terminal according to an embodiment of the invention; and

FIG. 6 is a structural representation of yet another terminal according to an embodiment of the invention.

The realization of the objects, the functional characteristics and the advantages of the invention will be further illustrated by referring to the drawings in conjunction with the embodiments.

### DETAILED DESCRIPTION OF THE EMBODIMENTS

The technical solutions of the invention will be further illustrated in conjunction with the drawings and specific embodiments of the invention. It should be noted that, the specific embodiments described herein are only used to explain the invention, rather than to limit the invention.

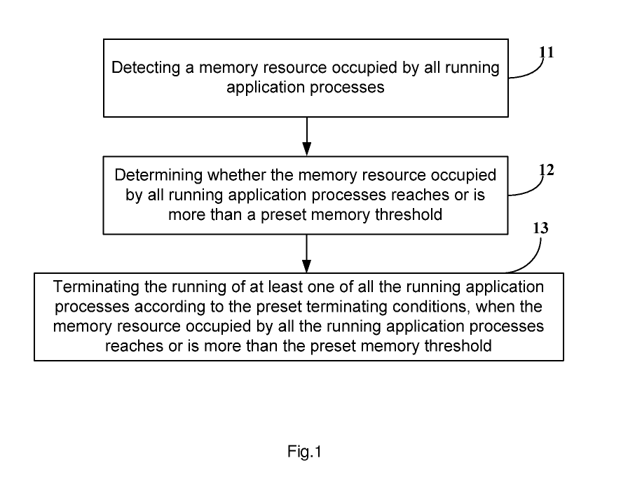

FIG. 1 is a schematic flow chart of a method for terminal acceleration according to an embodiment of the invention. The method shown in this embodiment may be operated on a terminal such as a mobile phone, a tablet computer, a desk-top computer and a portable computer, and includes Steps 11, 12 and 13 below.

At Step 11, a memory resource occupied by all running application processes is detected. For example, a terminal detects in real time the memory resource occupied by all running application processes.

At Step 12, it is determined whether the memory resource occupied by all running application processes reaches or is greater than a preset memory threshold.

For example, a terminal detects in real time whether the memory resource occupied by all running application processes reaches or is greater than a preset memory threshold, thus, the terminal can determine in real time whether the remaining memory resource in the terminal system is less than a threshold value for the remaining memory; or, the terminal may learn whether the memory resource occupied by all running application processes reaches or is greater than a preset memory threshold by detecting in real time whether the remaining memory resource is less than the threshold value for the remaining memory.

When the memory resource occupied by all running application processes reaches or is greater than the preset memory threshold, or when the remaining memory resource is less than the threshold value for the remaining memory, it is necessary for the terminal to release the memory resource for the purpose of acceleration.

Here, all the running application processes may include system processes and user processes.

At Step 13, the running of at least one of all the running application processes is terminated according to the preset terminating conditions, when the memory resource occupied by all the running application processes reaches or is greater than the preset memory threshold.

For example, when detecting that the memory resource occupied by all running application processes reaches or is greater than the preset memory threshold, or when detecting that the remaining memory resource is less than the threshold value for the remaining memory, the terminal autonomously terminates the running of partial application processes to release the corresponding memory resource, so that the processing speed of the remaining application processes may be improved, thereby attaining the object of acceleration.

It may be seen from the above flow that, no external operation interference is required in the acceleration of the terminal, that is, the acceleration is carried out by the terminal autonomously, as a result, automatic terminal acceleration is realized and the processing performance of the system of the terminal is improved.

Exemplarily, terminating the running of at least one of all the running application processes according to the preset terminating conditions may include:

terminating one or more from all the running application processes that are recorded in an automatic ending list.

The automatic ending list may be preset and saved on the terminal by a user, or may be generated by the terminal autonomously, or may be received by the terminal from another device.

For example, the terminal obtains oom_adj values of all application processes in the system thereof including system processes and user processes, and displays all application processes each with oom_adj value greater than 2 on a screen. After these application processes each with oom_adj value greater than 2 are ended, the system problem or user experience problem will be avoided on the terminal for a reason that: in an Android system, the oom_adj value of an application process represents the priority of the application process, where a greater oom_adj value represents a lower priority of the application process; and a smaller oom_adj value represents a higher priority of the application process, that is, the application process is greater important. For example, the oom_adj value of a foreground process is usually 0, and the oom_adj value of a visible process is 1.

The application processes with oom_adj values greater than 2 displayed on the screen may be displayed in the form of a list, and such list as displayed is a list of endable processes.

The terminal provides a selective check function for the list of endable processes, to enable the user to check and select a process to be ended.

The user may set a threshold value for the remaining memory. This threshold value is adopted by the terminal system to determine whether automatic acceleration is needed.

The list of endable processes checked and selected by the user and the threshold value of the remaining memory are saved on the terminal. Here, the list of endable processes is the above-mentioned automatic ending list.

After the above preparations are completed, the terminal detects the remaining memory in real time, or detects the occupied memory resource in real time.

When the terminal system detects that the remaining memory is lower than the threshold value or the memory resource occupied by the running application processes reaches or is greater than the preset memory threshold, the terminal automatically ends the application processes in the saved endable process list, i.e., the automatic ending list.

Or, terminating the running of at least one of all the running application processes according to the preset terminating conditions may include:

obtaining priority levels corresponding to all the running application processes; and

terminating the running of at least one of all the running application processes according to the obtained priority levels.

Exemplarily, terminating the running of at least one of all the running application processes according to the obtained priority levels includes:

displaying the application processes with priority levels lower than a preset priority level among all the running application processes;

receiving a user selection of one or more application processes; and

terminating the running of the one or more application processes corresponding among all the running application processes according to the user selection.

Or, terminating the running of at least one of all the running application processes according to the obtained priority levels may include:

terminating an application process with the lowest priority level among all the running application processes.

Exemplarily, after receiving a user selection of one or more application processes, the method further includes: recording the one or more application processes to obtain a list of applications to be automatically ended.

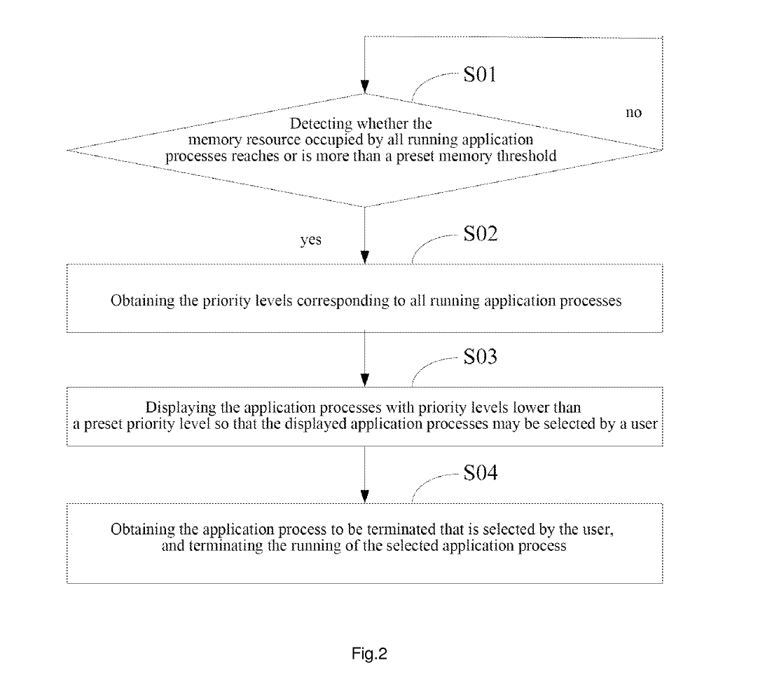

As shown in FIG. 2 which is a schematic flow chart of another method for terminal acceleration according to an embodiment of the invention, the method for terminal acceleration according to the invention, which may be operated on a terminal, includes Steps S01-S04 below.

At Step S01, it is detected whether the memory resource occupied by all running application processes reaches or is greater than a preset memory threshold; and if so, Step S02 is performed; and if not, the method returns to Step S01.

At Step S02, the priority levels corresponding to all running application processes are obtained.

The terminal detects whether the memory resource occupied by all running application processes currently reaches or is greater than a preset memory threshold, and when the memory resource occupied by all running application processes currently reaches or is greater than the preset memory threshold, the terminal obtains the priority levels corresponding to all running application processes. When there are too many running application processes on the terminal and the maximum load that the memory of the terminal can bear is exceeded, it is likely that the terminal may suffer from a slow running speed or even a breakdown due to the current insufficient memory redundancy, in the subsequent running process of the terminal. Therefore, in order to avoid the above situation, the terminal may take steps to release at least one of its memory according to the priority levels of all currently running application processes.

If the memory resource occupied by all running application processes on the terminal currently is less than the preset memory threshold, the terminal continues to detect whether the memory resource of the terminal occupied by all the running application processes currently reaches or is greater than the preset memory threshold.

The preset memory threshold is set according to the total capacity of the terminal memory and the specific requirement of the user on the terminal operating speed.

The priority level corresponding to each of all the running application processes depends on: the importance of the application process on the terminal, and the running state of the application corresponding to the application process at the moment when the priority level corresponding to the application process is obtained. For example, a system application process of the terminal, if terminated, may cause a failure of the terminal, and thus is provided with a relatively high priority level; but some dispensable application processes that are loaded on the background when the terminal is powered on are provided with low priority levels. Additionally, some software installed on the terminal such as browser and reader may be provided with priority levels that vary with different running states of the software; for example, when the user uses the browser to browse a web page on the display interface of the terminal, the priority level corresponding to the browser is relatively high at this time; and when the user directly starts a game on the terminal without exiting the browser, the browser continues running on the background of the terminal, but the priority level of the browser is lowered apparently at this time.

In an intelligent mobile phone with an Android operating system, for example, when a browser is displayed on the current interface of the mobile phone, the oom_adj value of the browser is 1; and when the browser exits the current display interface but continues running on the background of the mobile phone, the oom_adj value corresponding to the browser is greater than 2 at this time. Because the oom_adj value reflects the priority level of an application process on the mobile phone with the Android operating system, the greater the oom_adj value is, the lower the priority level of the corresponding application process will be.

At Step S03, application processes with priority levels lower than a preset priority level among all the running application processes are displayed for selection by a user.

After obtaining the priority levels corresponding to all running application processes currently, the terminal displays the application processes with priority levels lower than a preset priority level among all the above running application processes, so that the displayed application processes may be selected by a user; the preset priority level is set according to the requirement of the normal operation of the terminal, and the applications corresponding to the priority levels exceeding the preset priority level may include system application processes necessary for the normal operation of the terminal.

In a preferred embodiment, the terminal displays the applications corresponding to the currently running application processes with priority levels lower than a preset priority level in the form of a list, and arranges a check box ahead of each application displayed in the list, for the purpose of selective check by a user.

For an intelligent mobile phone with an Android operating system, for example, the priority levels of the currently running application processes may be represented by the corresponding oom_adj values; the greater the oom_adj value is, the lower the corresponding priority level will be. The oom_adj value corresponding to a system application process necessary for the operation of the terminal is usually 0; and the oom_adj value of an application process corresponding to an application displayed on the current interface of the terminal (for example the browser) is 1, and so on. For example, if the oom_adj value corresponding to the preset priority level is 2, the mobile phone may display the applications corresponding to the application processes with oom_adj values greater than 2, for the purpose of selective check by a user.

At Step S04, the application process to be terminated that is selected by the user is obtained, and the running of the application process is terminated, that is, the running of the corresponding application process among all the running application processes is terminated according to user selection.

The terminal automatically terminates the running of the application process checked and selected by the user, for automatic acceleration.

In a preferred embodiment, the terminal records the application process to be terminated that is checked and selected by the user, and when the terminal detects that the memory resource occupied by all running application processes reaches or is greater than the preset memory threshold, the terminal automatically terminates the running of the application process checked and selected by the user, to improve the operating speed of the terminal itself.

In a preferred embodiment, after the terminal terminates the application process checked and selected by the user, Step S01 is performed again to detect whether the memory resource occupied by all running application processes reaches or is greater than a preset memory threshold; and if the terminal detects that the memory resource occupied by all running application processes still reaches or is greater than the preset memory threshold, Steps S02 to S04 are repeated, until the terminal detects that the memory resource occupied by all running applications is less than the preset memory threshold.

In this embodiment, the priority levels corresponding to all running application processes are obtained when the terminal detects that the memory resource occupied by all running application processes reaches or is greater than the preset memory threshold, the application processes with priority levels lower than a preset priority level are displayed for selection by a user, and the running of the corresponding application process as selected by the user is terminated, so that the terminal can be automatically accelerated according to the current utilization condition of its memory and the running application processes on the terminal, thus the operating speed of the terminal may be improved and the functions of the terminal may be further diversified.

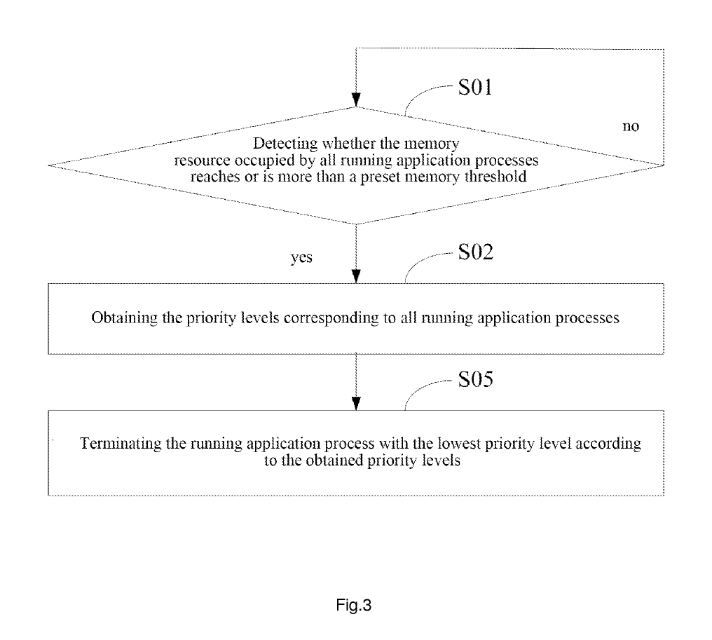

FIG. 3 shows a schematic flow chart of yet another method for terminal acceleration according to an embodiment of the invention, which is different from the embodiment of FIG. 2 in that a Step S05 is added; in this embodiment, only Step S05 will be specifically described, and reference may be made to the specific description of the embodiment shown in FIG. 2 for other steps concerned in the method for terminal acceleration according to the invention.

As shown in FIG. 3, after Step S02 of obtaining the priority levels corresponding to all running application processes, the method for terminal acceleration according to the invention further includes Step 05 below.

At Step S05, the running application process with the lowest priority level is terminated according to its priority level, that is, an application process with the lowest priority level among all running application processes is terminated.

After obtaining the priority levels corresponding to all running application processes, the terminal automatically terminates an application process with the lowest priority level among all running application processes according to the obtained priority levels.

For an intelligent mobile phone with an Android operating system, for example, when the memory resource of the mobile phone occupied by all currently running applications on the mobile phone is greater than a preset memory threshold, then according to the obtained priority levels corresponding to all the application processes, if a PDF reader corresponds to an oom_adj value of 6 which corresponds to a priority level of 1 at this time, for example, and the priority level of 1 is the lowest one obtained by the mobile phone, then the mobile phone automatically terminates the running of the application process corresponding to the PDF reader, thereby realizing the automatic acceleration of the mobile phone.

In a specific application scene, for example, when a user browses a PDF file (or similarly a WORD file or NetEase Mailbox, etc.) on a web page, the mobile phone automatically loads the PDF reader; and after the user has browsed the PDF file, the PDF reader may not be used subsequently in a long time, but the user might forget to manually close the PDF reader running on the background, as a result, more and more unnecessary application processes are running on the background of the mobile phone; if the mobile phone can terminate an application process with the lowest priority level among all running application processes according to the priority levels of the running application processes, the operating speed of the mobile phone may be effectively improved.

In this embodiment, the priority levels corresponding to all running application processes are obtained when a terminal detects that its memory resource occupied by all running application processes reaches or is greater than a preset memory threshold, and an application process with the lowest priority level among all the running application processes is terminated according to the obtained priority levels, so that the terminal can automatically terminate the running of an unnecessary application process according to the current utilization condition of the memory, thus the operating speed of the terminal may be improved and the functions of the terminal may be further diversified.

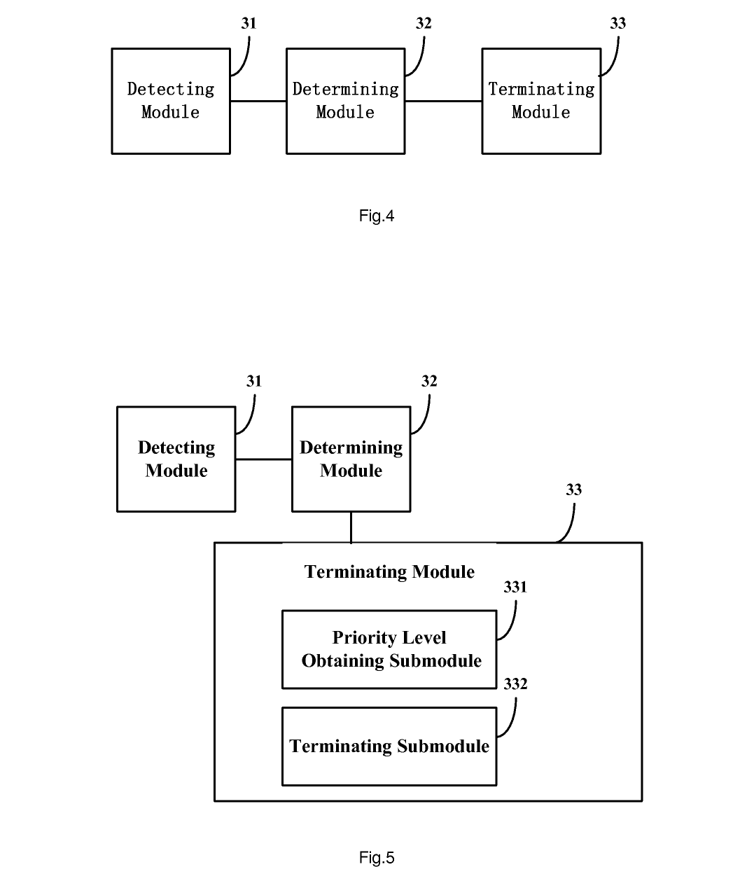

FIG. 4 is a structural representation of a terminal according to an embodiment of the invention; as shown in FIG. 4, the terminal according to the invention includes: a detecting module 31, a determining module 32 and a terminating module 33. It should be understood by one skilled in the art that, in addition to the detecting module 31, the determining module 32 and the terminating module 33, some basic functional modules such as a display and a transceiver are also included.

The detecting module 31 is adapted to detect a memory resource occupied by all running application processes.

the determining module 32 is adapted to determine whether the memory resource occupied by all running application processes reaches or is greater than a preset memory threshold.

The terminating module 33 is adapted to terminate the running of at least one of all the running application processes according to the preset terminating conditions, when the detecting module 31 detects that the memory resource occupied by all the running application processes reaches or is greater than a preset memory threshold.

In the terminal according to this embodiment, when the detecting module detects that the memory resource occupied by all running application processes reaches or is greater than the preset memory threshold, the terminating module terminates the running of at least one of all the running application processes to release the memory resource, so that the processing speed of the remaining application processes may be improved, thereby implementing the automatic acceleration of the terminal.

Exemplarily, the terminating module may be specifically adapted to terminate an application process among all the running application processes that is recorded in an automatic ending list. Here, the automatic ending list has been illustrated in detail in the above method embodiment.

Or, the terminating module may include:

a priority level obtaining submodule used for obtaining the priority levels corresponding to all running application processes; and

a terminating submodule used for terminating the running of at least one of all the running application processes according to the priority levels obtained by the priority level obtaining submodule.

Exemplarily, the terminating submodule may be specifically adapted to instruct a display of the terminal to display the application processes with priority levels lower than a preset priority level among all the running application processes, and receive a user selection of one or more application processes, and terminate the running of the one or more application processes among all the running application processes according to the user selection;

Or, the terminating submodule may be specifically adapted to terminate an application process with the lowest priority level among all the running application processes.

As shown in FIG. 5, the terminating module 33 includes a priority level obtaining submodule 331 and a terminating submodule 332.

The detecting module 31 of the terminal detects whether the memory resource occupied by all currently running application processes reaches or is greater than a preset memory threshold; and when the memory resource occupied by all currently running application processes reaches or is greater than the preset memory threshold, the priority level obtaining submodule 331 obtains the priority levels corresponding to all the running application processes. This is because that, when there are too many running application processes on the terminal and the maximum load that the memory of the terminal can bear is exceeded, it is likely that the terminal may suffer from a slow running speed or even a breakdown due to the current insufficient memory redundancy, in the subsequent running process of the terminal. In order to avoid the above situation, the terminating submodule 332 instructs the display of the terminal to display the application processes with priority levels lower than the preset priority level among all the running application processes so that the displayed application processes may be selected by a user, and the corresponding measures are taken to release at least one of the memory of the terminal according to user selection.

If the detecting module 31 of the terminal detects that the memory resource occupied by all currently running application processes is less than the preset memory threshold, the detecting module 31 continues to detect whether the memory resource of the terminal occupied by all the running application processes currently reaches or is greater than the preset memory threshold.

The preset memory threshold is set according to the total capacity of the terminal memory and the specific requirement of the user on the operating speed of the terminal.

The priority level corresponding to each of all the running application processes depends on: the importance of the application process on the terminal, and the running state of the application corresponding to the application process at the moment when the priority level corresponding to the application process is obtained. For example, a system application process of the terminal, if terminated, may cause a failure of the terminal, and thus is provided with a relatively high priority level; but some dispensable application processes that are loaded on the background when the terminal is powered on are provided with low priority levels. Additionally, some software installed on the terminal such as browser and reader may be provided with priority levels that vary with different running states of the software; for example, when the user uses the browser to browse a web page on the display interface of the terminal, the priority level corresponding to the browser is relatively high at this time; and when the user directly starts a game on the terminal without exiting the browser, the browser continues running on the background of the terminal, but the priority level of the browser is lowered apparently at this time.

In an intelligent mobile phone with an Android operating system, for example, when a browser is displayed on the current interface of the mobile phone, the oom_adj value of the browser is 1; and when the browser exits the current display interface but continues running on the background of the mobile phone, the oom_adj value corresponding to the browser is greater than 2 at this time. Because the oom_adj value reflects the priority level of an application process on the mobile phone with the Android operating system, the greater the oom_adj value is, the lower the priority level of the corresponding application process will be.

The terminating submodule 332 is adapted to instruct the display to display the application processes with priority levels lower than a preset priority level so that the displayed application processes may be selected by a user, and terminate the running of the corresponding application process among all the running application processes according to user selection.

After the priority level obtaining submodule 331 obtains the priority levels corresponding to all currently running application processes, the terminating submodule 332 instructs the display of the terminal to display the above application processes with priority levels lower than a preset priority level among all the running application processes, and receives a user selection of one or more application processes; the preset priority level is set according to the requirement of the normal operation of the terminal, and the application corresponding to the priority level exceeding the preset priority level include a system application process necessary for the normal operation of the terminal.

In a preferred embodiment, the terminating submodule 332 instructs the display of the terminal to display the applications corresponding to the currently running application processes with priority levels lower than the preset priority level in the form of a list, and sets a check box behind each application displayed in the list, for selective check by a user.

For an intelligent mobile phone with an Android operating system, for example, the priority levels of the currently running application processes may be represented by the corresponding oom_adj values; the greater the oom_adj value is, the lower the corresponding priority level obtained by the priority level obtaining submodule 331 will be; the oom_adj value corresponding to a system application process necessary for the operation of the above terminal is usually 0; and the oom_adj value of an application process corresponding to an application (e.g. the browser) displayed on the current interface of the terminal is 1, and so on. For example, if the oom_adj value corresponding to the preset priority level is 2, the terminating submodule 332 may instructs the display of the terminal to display the applications corresponding to the application processes with oom_adj values greater than 2, for selective check by a user.

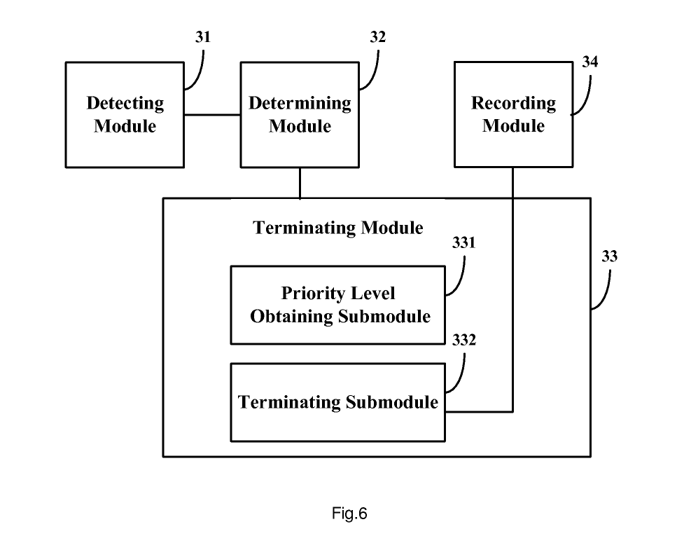

FIG. 6 is a structural representation of yet another terminal according to an embodiment of the invention, which is different from the embodiment of FIG. 5 only in that a recording module 34 is added; in this embodiment, only the recording module 34 will be specifically described, and reference may be made to the specific description of the embodiment shown in FIG. 5 for other modules involved in the terminal according to the invention.

Exemplarily, as shown in FIG. 6, the terminal according to the embodiment of the invention may further include a recording module 34, which is used for recording the one or more application processes to obtain a list of applications to be automatically ended, after the terminating submodule 332 receives a user selection of one or more application processes.

For example, the recording module 34 records the application process checked and selected by the user for terminating, and when the terminal detects, for the next time, that the memory resource occupied by all running application processes reaches or is greater than the preset memory threshold, the terminating submodule 332 automatically terminates the running of the application process checked and selected by the user, so that the operating speed of the terminal itself is improved.

In a preferred embodiment, when the terminating submodule 332 terminates the application process checked and selected by the user, the detecting module 31 continues to detect whether the memory resource occupied by all running application processes reaches or is greater than a preset memory threshold; and if the detecting module 31 detects that the memory resource occupied by all running application processes still reaches or is greater than the preset memory threshold, the above acceleration process is repeated, until the detecting module 31 detects that the memory resource occupied by all running applications is less than the preset memory threshold.

In the terminal provided in this embodiment, the priority level obtaining submodule obtains the priority levels corresponding to all running application processes when the detecting module detects that the memory resource occupied by all running application processes reaches or is greater than the preset memory threshold, and the terminating submodule instructs the display of the terminal to display the application processes with priority levels lower than a preset priority level so that the displayed application processes may be selected by a user, and terminates the running of the selected application process among all the running application processes according to the selection made by the user, so that the terminal is automatically accelerated according to the current utilization condition of its memory and the running application processes, thus the operating speed of the terminal may be improved and the functions of the terminal may be further diversified.

Exemplarily, the terminating submodule 332 may be further adapted to terminate an application process with the lowest priority level among all the running application processes.

After the priority level obtaining submodule 331 of the terminal obtains the priority levels corresponding to all running application processes, the terminating submodule 332 automatically terminates an application process with the lowest priority level among all the running application processes.

For an intelligent mobile phone with an Android operating system, for example, if the detecting module 31 detects that the mobile phone memory resource occupied by all currently running applications on the mobile phone is greater than a preset memory threshold, then, according to the priority levels corresponding to all the application processes that are obtained by the priority level obtaining submodule 331, for example, a PDF reader is provided with an oom_adj value of 6 corresponding a priority level of 1, which is the lowest priority level obtained by the mobile phone at this time, the terminating submodule 332 automatically terminates the running of the application process corresponding to the PDF reader, thereby automatically accelerating the mobile phone.

In a specific application scene, for example, when a user browses a PDF file (or similarly a WORD file or NetEase Mailbox, etc.) on a web page, the mobile phone automatically loads the PDF reader; and after the user has browsed the PDF file, the PDF reader may not be used subsequently in a long time, but the user might forget to manually close the PDF reader running on the background, as a result, more and more unnecessary application processes are running on the background of the mobile phone; if the terminating module 33 can terminate an application process with the lowest priority level among all running application processes according to the priority levels of the running application processes, the operating speed of the mobile phone may be effectively improved.

In this embodiment, the priority levels corresponding to all running application processes are obtained when the terminal detects that the memory resource occupied by all running application processes reaches or is greater than a preset memory threshold, and the running application process with the lowest priority level is terminated according to the obtained priority levels, thus, a resulting beneficial effect lies in that the terminal can automatically terminate the running of an unnecessary application process according to the current utilization condition of its memory to improve the operating speed of the terminal, so that the functions of the terminal may be further diversified.

An embodiment of the invention further discloses a storage medium containing computer-executable instructions, which, when executed by a computer processor, are used to execute steps of:

detecting a memory resource occupied by all running application processes;

determining whether the memory resource occupied by all running application processes reaches or is greater than a preset memory threshold; and

terminating the running of at least one of all the running application processes according to the preset terminating conditions, when the memory resource occupied by all the running application processes reaches or is greater than the preset memory threshold.

Exemplarily, terminating the running of at least one of all the running application processes according to the preset terminating conditions includes:

terminating an application process that is recorded in an automatic ending list among all the running application processes.

Or, terminating the running of at least one of all the running application processes includes:

obtaining priority levels corresponding to all the running application processes; and

terminating the running of at least one of all the running application processes according to the obtained priority levels.

Exemplarily, terminating the running of at least one of all the running application processes according to the obtained priority levels includes:

displaying the application processes with priority levels lower than a preset priority level among all the running application processes;

receiving a user selection of one or more application processes; and

terminating the running of the one or more application processes among all the running application processes according to the user selection.

Or, terminating the running of at least one of all the running application processes according to the obtained priority levels includes:

terminating an application process with the lowest priority level among all the running application processes.

Exemplarily, after receiving a user selection of one or more application processes, the method further includes: recording the one or more application processes to obtain a list of applications to be automatically ended.

Exemplarily, the priority level includes an oom_adj value.

Exemplarily, displaying the application processes with priority levels lower than a preset priority level among all the running application processes, includes:

displaying the application processes with oom_adj values greater than 2 for user selection.

The above description only shows some preferred embodiments of the invention, rather than limiting the scope of the invention. All equivalent structural or flow transformations made in light of the contents of the specification and drawings of the invention, which are applied directly or indirectly to other related technical fields, are included in the protection scope of the invention.

What is claimed is:

1. A method for terminal acceleration, using a terminal, comprising:
detecting a memory resource occupied by all running application processes;
determining whether the memory resource occupied by all running application processes reaches or is greater than a preset memory threshold; and
terminating the running of at least one of all the running application processes according to the preset terminating conditions, when the memory resource occupied by all the running application processes reaches or is greater than the preset memory threshold.

2. The method according to claim 1, wherein, terminating the running of at least one of all the running application processes comprises according to the preset terminating conditions:
terminating an application process that is recorded in an automatic ending list among all the running application processes;
or, terminating the running of at least one of all the running application processes comprises:
obtaining priority levels corresponding to all the running application processes; and
terminating the running of at least one or all the running application processes according to the obtained priority levels.

3. The method according to claim 2, wherein, terminating the running of at least one of all the running application processes according to the obtained priority levels comprises:
displaying the application processes with priority levels lower than a preset priority level among all the running application processes;
receiving a user selection of one or more application processes; and
terminating the running of the one or more application processes among all the running application processes according to the user selection;
or, terminating the running of at least one of all the running application processes according to the obtained priority levels comprises:
terminating an application process with the lowest priority level among all the running application processes.

4. The method according to claim 3, wherein, after receiving a user selection of one or more application processes, the method further comprises: recording the one or more application processes to obtain a list of applications to be automatically ended.

5. The method according to claim 2, wherein, the priority level comprises an oom_adj value.

6. The method according to claim 3, wherein, the priority level comprises an oom_adj value.

7. The method according to claim 4, wherein, the priority level comprises an oom_adj value.

8. The method according to claim 2, wherein, displaying the application processes with priority levels lower than a preset priority level among all the running application processes, comprises:
displaying the application processes with oom_adj values greater than 2 for user selection.

9. The method according to claim 3, wherein, displaying the application processes with priority levels lower than a preset priority level among all the running application processes, comprises:
displaying the application processes with oom_adj values greater than 2 for user selection.

10. The method according to claim 4, wherein, displaying the application processes with priority levels lower than a preset priority level among all the running application processes, comprises:
displaying the application processes with oom_adj values greater than 2 for user selection.

11. A terminal, comprising:
a detecting module, used for detecting a memory resource occupied by all running application processes;
a determining module, used for detecting whether the memory resource occupied by all running application processes reaches or is greater than a preset memory threshold; and
a terminating module, used for terminating the running of at least one of all the running application processes according to the preset terminating conditions, when the detecting module detects that the memory resource occupied by all the running application processes reaches or is greater than the preset memory threshold.

12. The terminal according to claim 7, wherein, the terminating module is specifically adapted to terminate the application process that is recorded in an automatic ending list among all the running application processes;
or, the terminating module comprises:
a priority level obtaining submodule, used for obtaining the priority levels corresponding to all the running application processes; and
a terminating submodule, used for terminating the running of at least one of all the running application processes according to the priority levels obtained by the priority level obtaining submodule.

13. The terminal according to claim 8, wherein, the terminating submodule is specifically adapted to instruct a display of the terminal to display the application processes with priority levels lower than a preset priority level among all the running application processes, and receive a user selection of one or more application processes, and terminate the running of the one or more application processes among all the running application processes according to the user selection;
or, the terminating submodule is specifically adapted to terminate an application process with the lowest priority level among all the running application processes.

14. The terminal according to claim 9, further comprising:
a recording module, which is used for recording the one or more application processes to obtain a list of applications to be automatically ended, after the terminating submodule receives a user selection of one or more application processes.

15. The terminal according to claim 12, wherein, the priority level obtained by the priority level obtaining submodule comprises an oom_adj value.

16. The terminal according to claim 13, wherein, the priority level obtained by the priority level obtaining submodule comprises an oom_adj value.

17. The terminal according to claim 14, wherein, the priority level obtained by the priority level obtaining submodule comprises an oom_adj value.

18. The terminal according to claim 12, wherein, the terminating submodule is specifically adapted to:
instruct the display of the terminal to display the application processes with oom_adj values greater than 2 for user selection.

19. The terminal according to claim 13, wherein, the terminating submodule is specifically adapted to:
instruct the display of the terminal to display the application processes with oom_adj values greater than 2 for user selection.

20. A non-transitory storage medium containing computer-executable instructions, which, when executed by a computer processor, performs:
detecting a memory resource occupied by all running application processes;
determining whether the memory resource occupied by all running application processes reaches or is greater than a preset memory threshold; and
terminating the running of at least one of all the running application processes according to the preset terminating conditions, when the memory resource occupied by all the running application processes reaches or is greater than the preset memory threshold.
